(19) United States
(12) Patent Application Publication
(10) Pub. No.: US 2026/0134044 A1
(43) Pub. Date: May 14, 2026

(54) RETRIEVAL OF CONTENT USING LINK-BASED SEARCHES INVOLVING IMAGE SEARCHES

(71) Applicant: ModeSens Inc., Dallas, TX (US)

(72) Inventor: Hang Li, Dallas, TX (US)

(21) Appl. No.: 19/385,845

(22) Filed: Nov. 11, 2025

Related U.S. Application Data
(60) Provisional application No. 63/719,038, filed on Nov. 11, 2024.

(51) Int. Cl. G06F 16/9535; G06F 16/532

(52) U.S. Cl. CPC G06F 16/9535; G06F 16/532

(57) ABSTRACT

Described herein are techniques and systems for retrieval of content using link-based involving image-based searches. In one embodiment, a method includes (a) receiving, from a computing device, a request including a link directed to source content; (b) analyze the source content to identify images associated with the link; and (c) initiating an image search based at least in part on the images. The method may further include (i) receiving related images corresponding to the image search; (ii) determining related links that are associated with the related images and that are directed to related source contents; (iii) analyzing the related source contents to identify parameters relating to the link included in the request; and (iv) outputting a search result to the computing device.

### CROSS-REFERENCE TO RELATED APPLICATIONS

This application claims priority to U.S. Application No. 63/719,038, filed Nov. 11, 2024, and which is hereby incorporated by reference in its entirety.

### TECHNICAL FIELD

This disclosure relates generally to link-based searching. For example, several embodiments of the present technology relate to retrieval of content using link-based searches that involve conducting image searches.

### BACKGROUND

Conventional search engines (such as Google® and Microsoft Bing®) permit a user to conduct a search and thereby identify webpages of interest by formulating a search query based on keywords and Boolean operators. While effective, this approach is not conducive to finding content related to that contained in a webpage. For example, converting the content found on a webpage into subsequent search queries can be time-consuming and inefficient for a user. Further, the utility of the search results is strongly dependent upon the skill of the user in terms of their ability to synthesize the information they find and reduce that information to an effective set of words or phrases. Combining this uncertainty with the iterative nature of most searches results in a process that can be time-consuming, frustrating, and less than optimal.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure. The drawings should not be taken to limit the disclosure to the specific embodiments shown, but are provided for explanation and understanding.

FIG. 1 is a diagram of an example environment that enables retrieval of content using link-based searches that involve conducting image searches in accordance with various embodiments of the present technology.

FIG. 2 is a partially schematic diagram of a computing architecture configured in accordance with various embodiments of the present technology.

FIGS. 3A and 3B are flow diagrams illustrating processes for retrieval of content using link-based searches that involve conducting image-based searches, in accordance with various embodiments of the present technology.

FIG. 4A is a partially schematic block diagram of a data processing pipeline configured in accordance with various embodiments of the present technology.

FIG. 4B is a block diagram of data relationships in accordance with various embodiments of the present technology.

FIGS. 4C and 4D are flow diagrams illustrating link-based search methods configured in accordance with various embodiments of the present technology.

FIG. 5 is a diagram illustrating a data processing pipeline configured in accordance with various embodiments of the present technology.

### DETAILED DESCRIPTION

The present disclosure is generally directed to techniques and systems for retrieval of content using link-based searches that can involve conducting image searches. For example, several embodiments disclosed herein include receiving, by a server and from a computing device, a search request for information related to source content included on a source webpage. The search request can include a link (e.g., a hyperlink or other form of pointer) directed to the source content and/or the source webpage. In response to the search request, the server may determine whether a database associated with the server includes the link. In some embodiments, the database stores associations between (i) one or more entities (e.g., content and/or webpages) and (ii) one or more links.

In response to a determination that the database does not include the link included in the search request, the server may (i) initiate an image search based on one or more images associated with the link (e.g., one or more images included in the source content and/or on the source webpage), and (b) provide a corresponding search result to the computing device that includes information of at least one entity associated with the link. In some embodiments, the database can be updated to store associations between the at least one entity and the link that are identified via the image search.

On the other hand, in response to a determination that the database includes the link included in the search request, the server may (a) identify an entity in the database that is associated with the link and (b) provide information of the entity to the computing device. In some embodiments, to supplement the information of the entity stored in the database, the server may additionally initiate an image search for related content based on one or more images associated with the link (e.g., included in the source content and/or on the source webpage).

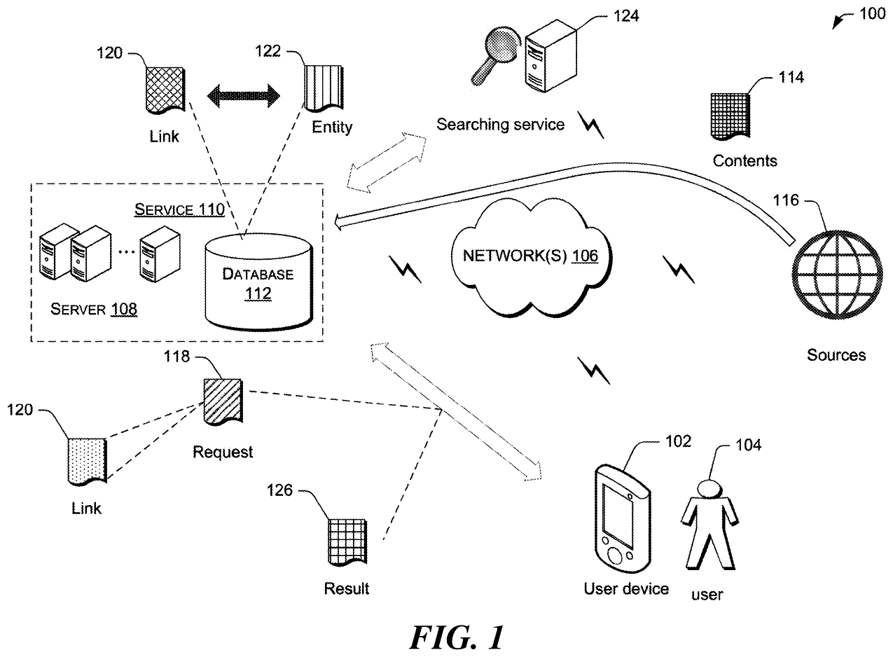

Specific details of several embodiments of the present technology are described herein with reference to FIGS. 1-5. Although many of the embodiments are described below with reference to retrieval of content using link-based searches, other applications in addition to those described herein are within the scope of the present technology. In addition, it should be noted that other embodiments in addition to those disclosed herein are within the scope of the present technology. Moreover, a person of ordinary skill in the art will understand that embodiments of the present technology can have configurations, components, and/or procedures in addition to those shown or described herein and that these and other embodiments can be without several of the configurations, components, and/or procedures shown or described herein without deviating from the present technology.

### A. Overview

As noted previously, conventional search engines (such as Google® and Microsoft Bing®) permit a user to conduct a search and thereby identify web pages of interest by formulating a search query based on keywords and Boolean operators. While effective, this approach is not conducive to finding content related to that contained in a webpage because converting the content found on a webpage into subsequent search queries can be time-consuming and inefficient for a user. Further, the utility of the search results is strongly dependent upon the skill of the user in terms of their ability to synthesize the information they find and reduce that information to an effective set of words or phrases. For example, using conventional search approaches, a user is required to process and convert webpage content into one or more keywords that can be used in a search engine to conduct a search for information related to a subject of interest. Based on the results, such an approach may require the user to iteratively repeat the process of adjusting the keywords and/or generating new keywords to locate and/or obtain search results of sufficient usefulness.

To address these concerns, several embodiments of the present technology described in detail below are generally directed to systems, methods, and computer-readable media that enable users, using a link to a webpage, to search for content and/or other information (also referred to herein as “entities”) related to a subject of interest contained in content included on the webpage. In some embodiments, the link can be used to conduct the search (a) in lieu of one or more search terms and/or keywords formulated by the users or (b) to supplement such search terms and/or keywords. For example, a user can initialize or “trigger” a link-based search by providing a search request that includes a link (e.g., a hyperlink or another type of pointer) directed to a source webpage containing a subject of interest within source content on the source webpage (e.g., a link directed to a source webpage from a commerce website that describes an item of interest, a link directed to a source webpage containing an article describing an event of interest, etc.). In turn, using the link, the present technology can conduct a search for entities related to the subject of interest. The search can include a search of a database storing associations between one or more entities (e.g., one or more webpages, contents included on those webpages, subjects of interest within the contents, and/or other information) and one or more links. The search can additionally include an image search to identify one or more entities associated with the link. In some embodiments, the image search can be based on one or more images (and/or associated metadata) included within the source content on the source webpage. In turn, the present technology can provide the user with a search result that includes an aggregation of entities related to the subject of interest contained in the source content included on the source webpage. For example, the search result can be presented to the user in the form of one or more webpages, images, and/or documents. As such, the present technology is expected to (a) enable users to quickly locate relevant information related to a subject of interest with minimum user actions and (b) significantly simply current search methods.

### B. Selected Embodiments of Link-Based Search Systems and Associated Methods

FIG. 1 is a diagram of an illustrative environment 100 that enables retrieval of content using link-based searches that can involve conducting image searches. The environment 100 includes a user device 102 associated with a user 104. The user 104 may include a user who uses a computing device (e.g., the user device 102) to exchange information via a network 106 with other computing devices.

The user device 102 may correspond to a wide variety of devices or components that are capable of initiating, receiving, or facilitating communications over the network 106. The user device 102 may include one or more of personal computing devices, electronic book readers (e.g., e-book readers), handheld computing devices, integrated components for inclusion in computing devices, home electronics, appliances, vehicles, machinery, landline telephones, network-based telephones (e.g., voice over IP (“VoIP”), cordless telephones, cellular telephones, smartphones, modems, personal digital assistants, laptop computers, gaming devices, media devices, etc.

The network 106 may include wired and/or wireless networks that enable communications between the various computing devices described in the environment 100. In some embodiments, the network 106 may include local area networks (LANs), wide area networks (WAN), mobile telephone networks (MTNs), and other types of networks, possibly used in conjunction with one another, to facilitate communication between the various computing devices (e.g., the user device 102 and a server 108).

The server 108 may be associated with a service 110. In some embodiments, the service 110 refers to a set of related software functionalities that may be reused for different purposes, together with the policies that, for example, retrieve content using link-based searches that may include or rely on image-based searches to provide more complete and/or accurate results. In some instances, the service 110 may establish a database 112 storing associations between links and content information corresponding to the links and/or enable the user 104 to query the database 112.

In some embodiments, the service 110 may collect links (e.g., hyperlinks) and contents 114 corresponding to the links from sources 116. In some embodiments, the service 110 may collect the links and the contents 114 corresponding to images relating to the links from the sources 116. For example, the sources 116 may include various webpages from online resources (e.g., item manufacturers, brandings, social media network).

In some embodiments, the service 110 may extract entity information from the contents 114 and determine one or more entities based on the entity information. For example, the service 110 may identify a link and extract contents corresponding to the link. In some embodiments, the service 110 may identify images associated with the link and extract contents (e.g., a copy of the images, metadata) corresponding to the images. Further, the service 110 may identify an entity and extract the representation as well as one or more features of the entity based on the contents. In some embodiments, the service 110 may (i) associate the entity with the link or the images and (ii) store the association in the database 112. For example, the service 110 may associate the link or related images to a representation of the entity and then store the association between the link or related images and the representation in the database 112. In these instances, the entity may correspond to one or more links and one or more images.

In some embodiments, the entity information may include representations of entities and features of the entities. For instance, an example of the entity may include an item, a document (e.g., a patent or patent application), an article, a drug, a piece of news. Accordingly, the representation of an entity may be a unique ID of the entity such as a manufacturer ID of an item, a serial number of a patent document, and a Digital Object Identifier (DOI) number of an article. In some embodiments, a feature of an entity may include descriptions of the entity, a person associated with the entity, and/or a price of the entity. For example, suppose that the entity is an item (e.g., cloth), the feature of the item may include descriptions of the cloth, celebrities who wear the cloth, and a price of the cloth.

In some embodiments, the service 110 may enable the user 104 to query the database 112, perform link-based and/or image-based searches, and provide search results to the user device 102. For example, the server 108 may receive a request 118 from the user device 102, and the request 118 may include a link 120 (e.g., a hyperlink or another type of pointer). In turn, the server 108 may perform searches in the database 112 to determine whether the database 112 includes the link 120. In response to a determination that the database 112 includes the link 120, the server 108 may determine an entity 122 corresponding to the link 120 and extract features and representation of the entity 122. Further, the server 108 may transmit a result 126 including, for example, the features and representation of the entity 122 to the user device 102.

In some embodiments, the server 108 may determine that the database 112 does not include the link 120. In turn, the server 108 may (a) retrieve content information corresponding to the website and/or the webpage referenced by the link 120 and (b) analyze the content information to generate topic information, which can include one or more vectors and/or keywords. For example, the server 108 may determine a keyword based on the content information and query a searching service 124 using the keyword. Further, the server 108 may (i) receive multiple results (each including a link) and (ii) select one or more links. The server 108 may further search the database 112 using the one or more links to determine an entity corresponding to the one or more links.

As another example, the server 108 may analyze the content information corresponding to the website and/or the webpage referenced by the link 120 to identify one or more images within the content information and/or metadata associated with those one or more images. In turn, the server 108 may generate topic information based on the one or more images and/or the associated metadata. The topic information may include one or more vectors and/or keywords. For example, the server 108 may (a) determine a keyword based on the one or more images and/or the associated metadata and (b) query a searching service 124 using the keyword. In some embodiments, the server 108 may query the searching service 124 using the one or more images directly, such as to initiate or perform an image search for other images related to the one or more images. Further, the server 108 may (i) receive multiple results (each including a link) and (ii) select one or more links. The server 108 may further search the database 112 using the one or more links to determine an entity corresponding to the one or more links.

In the event the server 108 identifies an entity in the database 112, the server 108 may provide features and a representation of the entity to the user device 102. If the server 108 does not identify any entity based on the one or more links, the server 108 may further generate topic vectors (e.g., multiple dimensional vectors). The server 108 may calculate distances between the topic vector and topic vectors corresponding to links stored in the database 112. Further, the server 108 may select a link from the links based on the distances and identify an entity corresponding to the link.

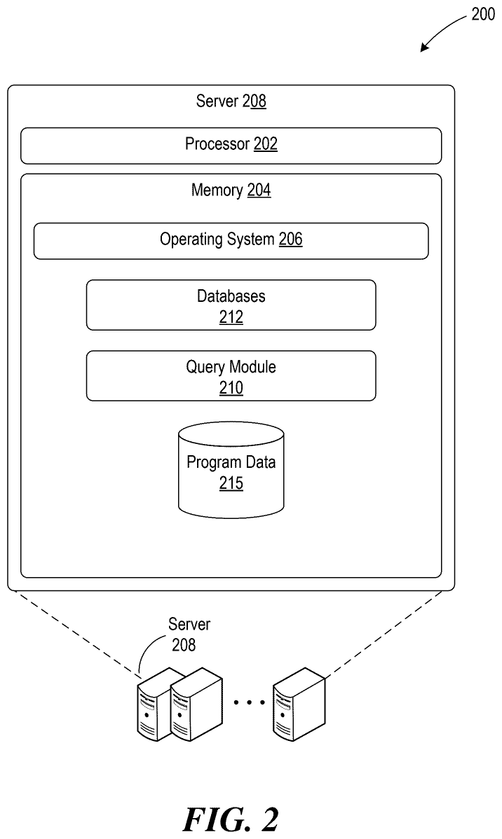

FIG. 2 is a schematic diagram of an illustrative computing architecture 200 configured to enable retrieval of content using link-based searches that may include or rely on image-based searches to provide more complete and/or accurate results. The computing architecture 200 can be an example of at least a portion of the service 110 of FIG. 1 (which may include additional modules, kernels, data, and/or hardware), or of other services and/or computing architectures configured in accordance with various embodiments of the present technology.

The computing architecture 200 may include a server 208 having a processor 202 and memory 204. The memory 204 may store various modules, applications, programs, or other data. The memory 204 may include instructions that, when executed by the processor 202, cause the processor 202 to perform the operations described herein for the server 208. The processor 202 may include one or more graphics processing units (GPUs) and one or more central processing units (CPUs).

The server 208 may have additional features and/or functionality. For example, the server 208 may also include additional data storage devices (removable and/or non-removable). Computer-readable media may include, at least, two types of computer-readable media, namely computer storage media and communication media. Computer storage media may include volatile, non-volatile, removable, and/or non-removable media implemented in any method or technology for storage of information, such as computer-readable instructions, data structures, program modules, program data, or other data. The system memory, the removable storage, and/or the non-removable storage are all examples of computer storage media. Computer storage media includes, but is not limited to, RAM, ROM, EEPROM, flash memory or other memory technology, CD-ROM, digital versatile disks (DVD), or other optical storage, magnetic cassettes, magnetic tape, magnetic disk storage or other magnetic storage devices, or any other medium that can be used to store the desired information and which can be accessed by the server 208. Any such computer storage media may be part of the server 208. Moreover, the computer-readable media may include computer-executable instructions that, when executed by the processor(s), perform various functions and/or operations described herein.

In contrast, communication media may embody computer-readable instructions, data structures, program modules, and/or other data in a modulated data signal, such as a carrier wave, or another mechanism. As defined herein, computer storage media does not include communication media.

The memory 204 may store an operating system 206 as well as program data 215, a database 212, and a query application 210. Database 112 may be configured to store associations between links (e.g., the link 120 of FIG. 1) and entities (e.g., the entity 122 of FIG. 1).

The query application 210 may (i) receive a request including a link (e.g., a hyperlink or another type of pointer) directed to source content and (ii) determine whether the database 212 includes the link. For example, the database 212 may be an example of the database 112 of FIG. 1, and/or may store (a) information (e.g., features and/or representations) of multiple entities and (b) associations between each entity and one or more links. For example, when an entity is an item, a representation of the entity may be a unique ID of the item. As another example, when an entity is a patent document, a representation of the entity may be a serial number associated with the patent document. In some embodiments, the query application 210 may further collect multiple links and contents corresponding to the multiple links. The query application 210 may extract information from the contents, associate the information with the multiple entities, and store the information in the database 212.

In response to a determination that the database 212 includes the link included in the request, the query application 210 may identify an entity corresponding to the link, extract information of the entity, and provide the information to a user device (e.g., the user device 102 of FIG. 1). For example, information of multiple entities may include a representation of an individual entity, a feature of the individual entity, one or more links, and an association between the representation and the one or more links. In some implementations, the query application 210 may (a) retrieve the representation and the feature of the entity and (b) provide the representation and the feature to a user device.

In response to a determination that the database 112 does not include the link included in the request, the query application 210 may analyze the source content to determine one or more parameters and perform a search based on the one or more parameters, for example using a searching service (e.g., the searching service 124 of FIG. 1). The query application 210 may further obtain a search result and provide the search result to the computing device. For example, the server 208 may download and analyze the source content that the link returns to determine these parameters.

In some embodiments, the query application 210 may analyze the source content to determine one or more images relating to the link included in the request, and perform a search based on the one or more images, for example using the searching service. The query application 210 may further obtain a search result and provide the search result to a computing device (e.g., a user device and/or the computing device that submitted the request including the link). For example, the server 208 may download and analyze the source content that the link returns to determine these parameters.

In some embodiments, the one or more parameters are one or more keywords. The query application 210 may perform searches based on the one or more parameters using the searching service. The query application 210 may further identify a predetermined number of returned results, retrieve links corresponding to the returned results, and search the database 212 to identify one or more entities corresponding to at least one of the links. Further, the query application 210 may generate the search result based on the one or more entities.

In some embodiments, the query application 210 may load contents corresponding to the link included in the request, extract a topic vector from the contents, and calculate distances between the topic vector and topic vectors corresponding to links stored in the database 212. Further, the query application 210 may select an additional link from the links based on the distances and identify an additional entity corresponding to the additional link.

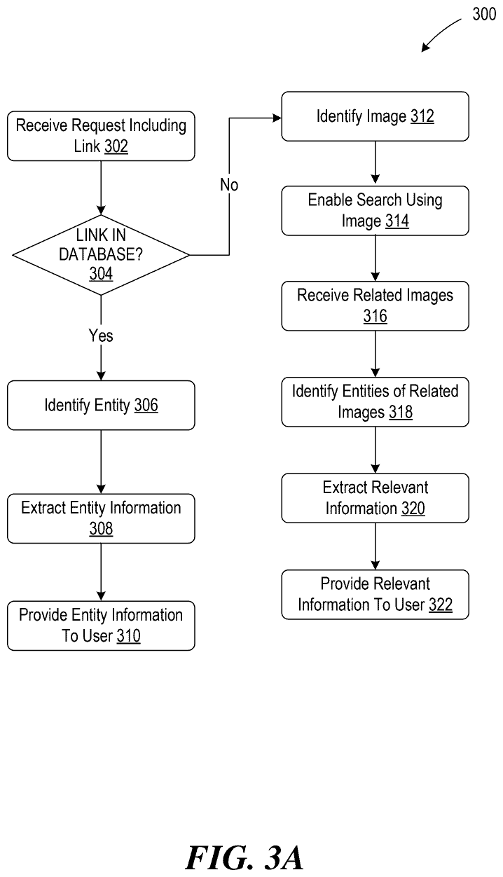

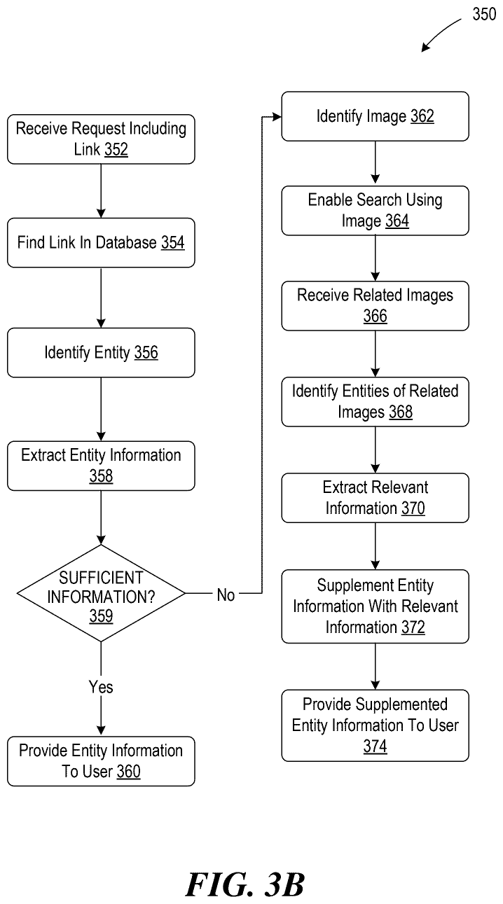

FIG. 3A is a flow diagram illustrating a process 300 for retrieval of content using link-based searches that may include or rely on image-based searches to provide more complete and/or accurate results, in accordance with various embodiments of the present technology. The process 300 is illustrated as a collection of blocks or steps, which represents a sequence of operations that can be implemented in hardware, software, or a combination thereof. In the context of software, the blocks represent computer-executable instructions that, when executed by one or more processors, cause the one or more processors to perform the recited operations. Computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process 300. Other processes described throughout this disclosure, in addition to the process 300, shall be interpreted accordingly. The process 300 is described concerning the environment 100 illustrated in FIG. 1 and the computing architecture 200 illustrated in FIG. 2. However, the process 300 may be implemented in other environments and/or other computing architectures.

At block 302, the process 300 begins by the server 108, 208 receiving a request 118 including a link 120 (e.g., a hyperlink or another type of pointer) directed to a source content, which is associated with an entity 122. For example, the entity 122 can be an item shown and/or described in the source content, and the representation can be a unique ID of the item. As another example, the entity 122 can be a patent document, and the representation can be a serial number or patent number associated with the patent document. The request 118 may be received from a user device 102 or another computing device.

At block 304, the process 300 continues by the server 108, 208 determining whether a database 112, 212 associated with the server 108, 208 includes the link 120. For example, the database 112, 212 may store information of multiple entities and associations between each entity and one or more corresponding links. In some embodiments, the server 108, 208 may further collect multiple links and contents corresponding to the multiple links. The server 108, 208 may extract the information from the contents, associate the information with one or more of the multiple entities, and store the information in the database 112, 212.

In the event that the server 108, 208 determines the database 112, 212 includes the link 120 (block 304: Yes), the process 300 continues to block 306 by the server 108, 208 identifying the entity 122 corresponding to the link 120.

At block 308, the process 300 continues by the server 108, 208 extracting and/or retrieving information of or related to the entity 122. For example, the extracted/retrieved information may include a representation of the entity, a feature of the entity, all or a subset of the one or more corresponding links, and/or one or more associations between the representation and the one or more corresponding links.

At block 310, the process 300 continues by the server 108, 208 providing the information extracted at block 308 to a user device 102. For example, the server 108, 208 may retrieve the representation and the feature of the entity from the database 112, 212 and provide the representation and the feature to the user device 102 or another computing device that provided the request at block 302.

Referring again to block 304, in the event that the server 108, 208 determines the database 112, 212 does not include the link 120 (block 304: No), the server 108, 208 may analyze the source content to identify (a) one or more images included in the source content and/or (b) metadata associated with the one or more images. For example, the one or more images may be associated with link 120.

At block 314, the process 300 continues by the server 108, 208 enabling, conducting, or initiating a search (e.g., using the searching service 124) based on the one or more images included in the source content or otherwise associated with the link 120. In some embodiments, the search based on the one or more images includes an image search for images related or similar to the one or more images. In these and other embodiments, the search based on the one or more images includes a keyword search, such as based on metadata associated with the one or more images.

At block 316, the process 300 continues by the server 108, 208 receiving (e.g., from the searching service 124) and/or identifying at least one image (“related image(s)”) that is/are related (or similar) to the one or more images identified at block 312.

At block 318, the process 300 continues by the server 108, 208 identifying at least one entity of (or associated with) the related image(s). At block 320, the process 300 continues by the server 108, 208 extracting relevant information of the at least one entity identified at block 318. For example, the relevant information may include a representation of the at least one entity of the related image(s), a feature of the at least one entity of the related image(s), the corresponding related image(s), and/or an association between the representation and the related image(s).

At block 322, the process 300 continues by the server 108, 208 providing all or a subset of the extracted information to the user device 102 or the other computing device that provided the request at block 302.

Referring again to block 304, although the process 300 is illustrated in FIG. 3A as only conducting an image search when the server 108, 208 determines that the link 120 is not in the database 112, 212 (block 304: No), the process 300 is not so limited. For example, in other embodiments, the process 300 can include executing all or a subset of blocks 312-322 in the event the server 108, 208 determines that the link 120 is included in the database 112, 212 (block 304: Yes), such as to supplement entity information included in the database 112, 212. Continuing with this example, this can ensure that entity information provided to the user device 102 and/or the other computing device that provided the request at block 302 includes most-up-to date entity information that may be available when conducting an image-based search but not yet included in the database 112, 212.

Additionally, or alternatively, although the process 300 is illustrated in FIG. 3A as conducting only an image search to identify/retrieve relevant entity information, the process 300 is not so limited. For example, in other embodiments, the process 300 can include enabling, conducting, or initiating a keyword search (e.g., using the searching service 124) to identify/retrieve relevant entity information in addition to or in lieu of enabling, conducting, or initiating the image search at blocks 312-322. Continuing with this example, the process 300 can include (a) analyzing the source content to identify text, images, and/or metadata (e.g., associated with the text and/or the images) included in the source content; (b) generating keywords and/or topic vectors based on the text, images, and/or metadata; (c) enabling, conducting, or initiating a keyword search (e.g., using the search service 124) based on the keywords; (d) receiving search results of the keyword search; (e) identifying at least one entity of (or associated) with the search results; (f) extracting relevant information of the at least one entity; and/or (g) providing the relevant entity information to the user device 102 or the other computing device that provided the request at block 302. In some cases, the relevant entity information can be provided to the user device 102 or the other computing device in addition to entity information extracted at block 308, such as to supplement the entity information extracted/retrieved at block 308. The search service 124 used to conduct the keyword search can be a same search service as or a different search service from the search service 124 used to conduct the image search. The keyword search can be conducted when the server 108, 208 determines that the link 120 is not in the database 112, 212 (block 304: No) and/or when the server 108, 208 determines that the link 120 is in the database 112, 212 (block 304: Yes).

FIG. 3B is a flow diagram illustrating a process 350 for retrieval of content using link-based searches that may include or rely on image-based searches to provide more complete and/or accurate results, in accordance with various embodiments of the present technology. The process 350 is illustrated as a collection of blocks or steps, which represents a sequence of operations that can be implemented in hardware, software, or a combination thereof. In the context of software, the blocks represent computer-executable instructions that, when executed by one or more processors, cause the one or more processors to perform the recited operations. Computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process 350. Other processes described throughout this disclosure, in addition to the process 300, shall be interpreted accordingly. The process 350 is described concerning the environment 100 illustrated in FIG. 1 and the computing architecture 200 illustrated in FIG. 2. However, the process 350 may be implemented in other environments and/or other computing architectures.

At block 352, the process 350 begins by the server 108, 208 receiving a request 118 including a link 120 (e.g., a hyperlink or another type of pointer) directed to a source content, which is associated with an entity 122. For example, the entity 122 can be an item shown and/or described in the source content, and the representation can be a unique ID of the item. As another example, the entity 122 can be a patent document shown and/or described in the source content, and the representation can be a serial number or patent number associated with the patent document. The request 118 may be received from a user device 102 or another computing device.

At block 354, the process continues by the server 108, 208 determining that a database 112, 212 associated with the server 108, 208 includes the link 120. For example, the database 112, 212 may store information of multiple entities and associations between each entity and one or more corresponding links. In some embodiments, the server 108, 208 may further collect multiple links and contents corresponding to the multiple links. The server 108, 208 may extract the information from the contents, associate the information with one or more of the multiple entities, and store the information in the database 112, 212.

At block 356, the process 350 continues by the server 108, 208 identifying the entity 122 corresponding to the link 120. At block 358, the process 350 continues by the server 108, 208 extracting and/or retrieving information of (or related to) the entity 122. For example, the extracted/retrieved information may include a representation of the entity, a feature of the entity, all or a subset of the one or more corresponding links, and/or one or more associations between the representation(s) and the one or more corresponding links.

At block 359, the process 350 continues by the server 108, 208 determining whether the information extracted/retrieved at block 358 is sufficient. For example, the server 108, 208 may determine whether the association between the representation and the one or more corresponding links that were extracted/retrieved at block 358 is sufficient. As another example, the server 108, 208 may determine that there is an insufficient amount of entity information saved to the database 112, 212 and/or extracted/retrieved at block 358.

In the event that the server 108, 208 determines that the information extracted/retrieved at block 358 is sufficient (block 359: Yes), the process 350 continues to block 360 by the server 108, 208 providing all or a subset of the information to the user device 102 or another computing device that provided the request at block 352.

Referring again to block 359, in the event that the server 108, 208 determines that the information extracted/retrieved at block 358 is not sufficient (block 359: No), the process 350 continues to block 362 by the server 108, 208 analyzing the source content to identify (a) one or more images included in the source content and/or (b) metadata associated with the one or more images. For example, the one or more images may be associated with the link 120.

At block 364, the process 350 continues by the server 108, 208 enabling, conducting, or initiating a search (e.g., using the search service 124) based on the one or more images included in the source content or otherwise associated with the link 120. In some embodiments, the search based on the one or more images includes an image search for images related or similar to the one or more images. In these and other embodiments, the search based on the one or more images includes a keyword search, such as based on metadata associated with the one or more images.

At block 366, the process 300 continues by the server 108, 208 receiving (e.g., from searching service 124) and/or identifying at least one image (“related image(s)”) that is/are related (or similar) to the one or more images identified at block 312.

At block 368, the process 350 continues by the server 108, 208 identifying at least one entity of (or associated with) the related image(s). At block 370, the process 350 continues by the server 108, 208 extracting relevant information of the at least one entity identified at block 356. For example, the relevant information may include a representation of the at least one entity of the related image(s), a feature of the at least one entity of the related image(s), the corresponding related image(s), and/or an association between the representation and the related image(s).

At block 372, the process 350 continues by the server 108, 208 supplementing the entity information extracted/retrieved at block 358 with the relevant information extracted/retrieved at block 370 based on the image search. For example, the server 108, 208 may generate a supplemented search result that includes both entity information from block 358 that is based on the search of the database 112, 212 using the link and relevant information from block 370 that is based on the search using the one or more images (and/or associated metadata) included in the source content.

At block 374, the process 350 continues by the server 108, 208 providing the supplemented entity information to the user device 102. For example, the supplemented entity information may include both entity information from block 358 that is based on the search of the database 112, 212 using the link and relevant information from block 370 that is based on the search using the one or more images (and/or the associated metadata) included in the source content.

Referring again to block 359, although the process 350 is illustrated in FIG. 3B as only conducting an image search when the server 108, 208 determines that the information extracted/retrieved at block 358 is not sufficient (block 359: No), the process 350 is not so limited. For example, in other embodiments, the process 350 can include executing all or a subset of blocks 362-374 in the event the server 108, 208 determines that the information extracted/retrieved at block 358 is sufficient (block 359: Yes). Continuing with this example, this can ensure that entity information provided to the user device 102 and/or the other computing device that provided the request at block 352 includes most-up-to date entity information that may be available when conducting an image-based search but not yet included in the database 112, 212.

Additionally, or alternatively, although the process 350 is illustrated in FIG. 3B as conducting only an image search to identify/retrieve supplement entity information, the process 350 is not so limited. For example, in other embodiments, the process 350 can include enabling, conducting, or initiating a keyword search (e.g., using the searching service 124) to identify/retrieve supplement entity information in addition to or in lieu of enabling, conducting, or initiating the image search at blocks 364-370. Continuing with this example, the process 350 can include (a) analyzing the source content to identify text, images, and/or metadata (e.g., associated with the text and/or the images) included in the source content; (b) generating keywords and/or topic vectors based on the text, images, and/or metadata; (c) enabling, conducting, or initiating a keyword search (e.g., using the search service 124) based on the keywords; (d) receiving search results of the keyword search; (e) identifying at least one entity of (or associated) with the search results; (f) extracting relevant information of the at least one entity; and/or (g) supplementing the entity information extracted/retrieved at block 358. The search service 124 used to conduct the keyword search can be a same search service as or a different search service from the search service 124 used to conduct the image search. The keyword search can be conducted when the server 108, 208 determines that the information extracted/retrieved at block 358 is not sufficient (block 359: No) and/or when the server 108, 208 determines that the information extracted/retrieved at block 358 is sufficient (block 359: Yes).

The present disclosure is further described with reference to the following examples. These examples are provided for purposes of illustration only and are not intended to be limiting unless otherwise specified. Thus, the present disclosure should in no way be construed as being limited to the following examples, but rather, should be construed to encompass any and all variations which become evident as a result of the teaching provided herein.

As noted, conventional search engines (such as Google® and Microsoft Bing®) permit a user to conduct a search and identify webpages of interest by formulating a search query based on keywords and Boolean operators. While effective, this approach is not conducive to finding content related to that contained in a webpage because interpreting the content found on a webpage and generating sufficiently relevant keywords, followed by constructing and executing multiple search queries, can be time-consuming and inefficient for a user.

One reason for this is that because keywords are generated by the user and the number of keywords (search terms) used are necessarily limited, a significant amount of relevant or potentially relevant information from the original webpage or article may be lost. This means that the results of such a search methodology may be inaccurate (in the sense that the new information found is not as relevant as desired), as the keywords used are both limited and may be somewhat less than optimal (as they depend on the user's familiarity with the content and the process of constructing effective search queries).

As a result, users may have to perform an iterative process of carefully reviewing the results of a search (which may be multiple webpages), adjusting their queries, performing another search, and if necessary, repeating the process in order to confidently find content related to (or relevant to) that located on a particular webpage. This is very inconvenient and prone to user error, as it requires some degree of skill to convert the content of a webpage into the “right” or most effective keywords that will lead to the related content the user is seeking.

In contrast, the link-based searches of the present technology, which may include or rely on image-based searches to provide more complete and/or accurate results, do not require that a user converts the content of a webpage into one or more keywords and then execute subsequent queries, and instead more directly finds matches between the full content of a source webpage and the content of other webpages. Thus, the link-based searches of the present technology help a user to obtain content related to that of the desired webpage without specifying keywords and formulating a set of search queries.

In operation, embodiments of the system and methods can be considered in two different use cases or scenarios: (1) a search for a specific entity; or (2) a search for a non-specific entity.

### Scenario 1: Search for a Specific Entity

Example use case: when someone is looking at a product page on a merchant website, he/she has to spend extra time to construct and execute searches using different keywords to find related information that may be potentially relevant to the consumer. This information might include, for example, coupons, sales, promotional offers, available inventory information from other vendors, product reviews, social media “chatter” regarding a product or manufacturer, etc. However, by using the link-based searches of the present technology, which may include or rely on image-based searches to provide more complete and/or accurate results, the consumer can simply activate a bookmark or browser plugin, or copy and enter/paste the link into the search field of a search engine to execute a search. In response, a server can return an aggregated and comprehensive view of the product from multiple sources of related and presumably relevant content. This permits the user to quickly access a larger and more comprehensive set of information about the product, its availability, its pricing, reviews, etc. This saves the user time and enables users who are not as familiar or comfortable with constructing their own search queries to obtain valuable and useful information.

The specific entity use case is one in which an object or subject of interest is identified, such as a product, event, or a celebrity. Taking a product as an example, at present, information about or related to a product is typically separated across multiple webpages that are populated with different types of content by different owners. For example, a pair of the same designer shoes may be sold on-line by multiple merchants and displayed on multiple webpages. However, when a user wants to make a purchase, he/she would be interested in knowing all related information for that particular product in order to make the “best” purchasing decision. This might include pricing options, sales, promotional offers, availability options, product reviews, images, vendor return policies, etc.

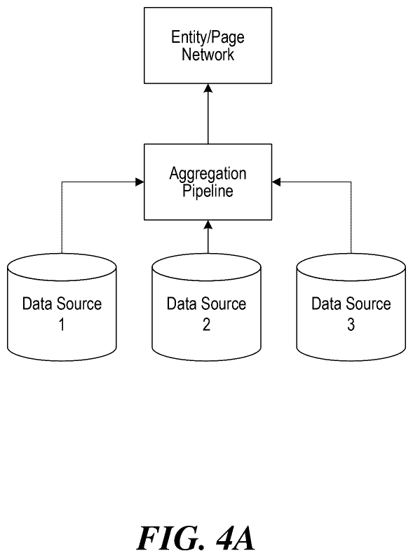

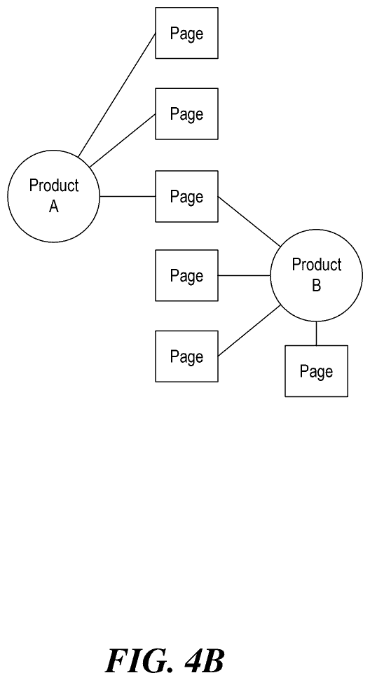

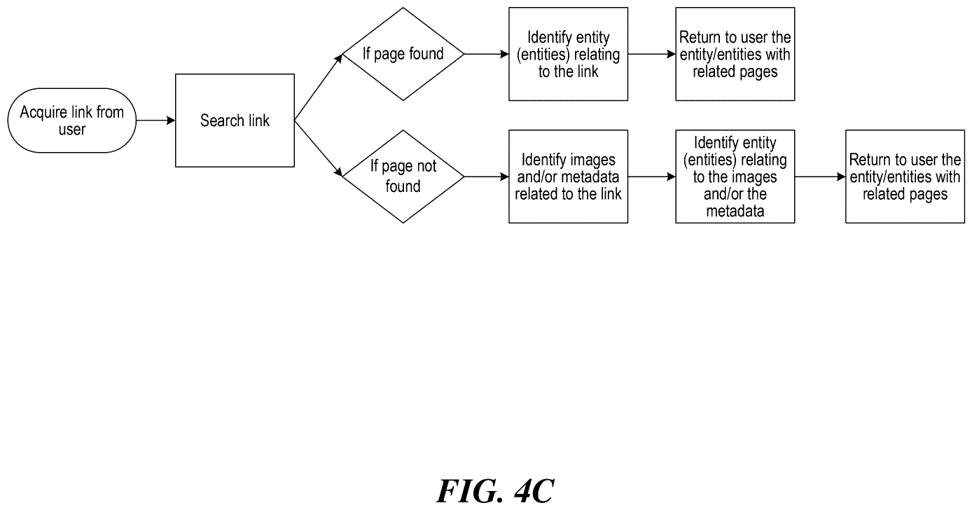

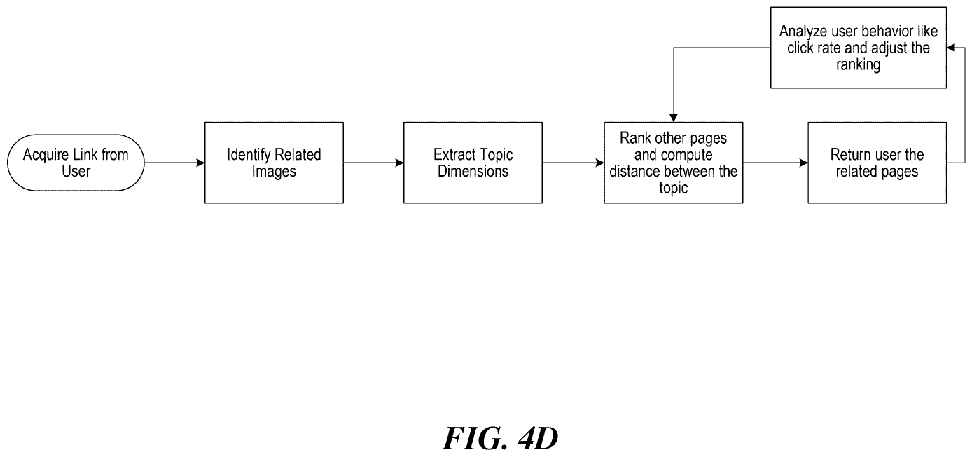

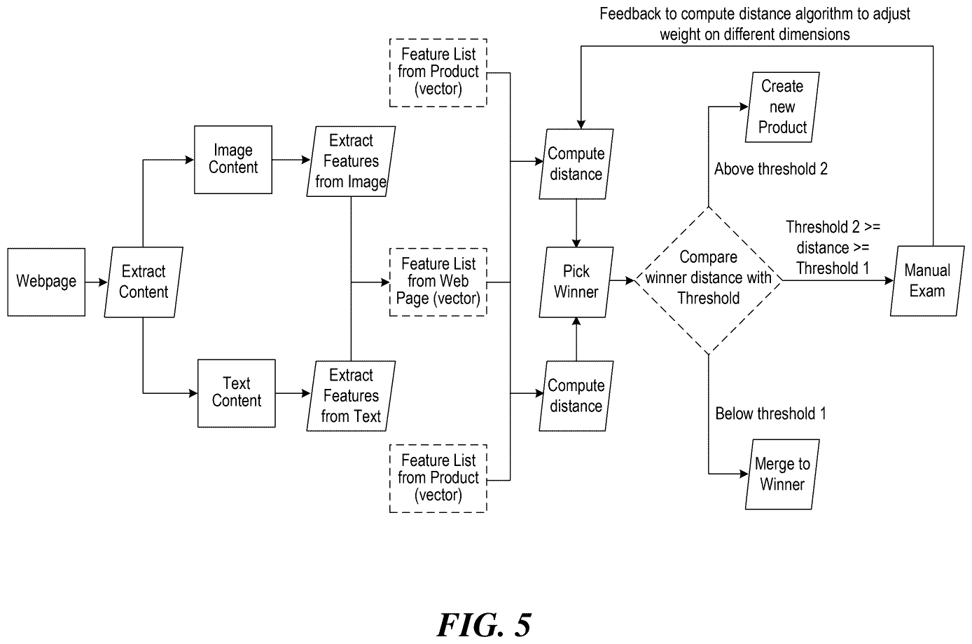

In some embodiments, a data acquisition and processing pipeline (as illustrated in FIG. 4A and FIG. 5) may be used to access content from different webpages across the same or different websites, and operate to identify relationships and shared entities between the different pages across the same domain or different domains. This permits the system and methods to identify a set of webpages containing information about a particular product (e.g., inventory information for multiple merchants, blog posts about the product, promotional offers, and users' reviews). In some embodiments, the pipeline may implement one or more types of machine learning technologies or methods to identify a possible relationship between pages or between items of content on pages. For example, as explained herein with reference to Scenario 1, the features could be extracted from text, pictures/images, and/or metadata (e.g., associated with the text and/or the pictures/images) of a webpage of a product. The system can then compare the features extracted with features of existing products in a database to compute a metric or distance between the two products. The product in the database having the shortest metric/distance to the product from the webpage could be treated as the most similar one. If the distance of the most similar one meets a certain threshold, then the webpage containing the product could be merged with the most similar one found in the database. This permits the product/entity to be identified from the data sources, along with information about the relationships between the product/entity and the set of pages containing related content. This permits construction of a network indicating the relationships between the product/entity and the various pages of content, as illustrated in FIG. 4B.

As on the internet, each page may be represented by a link (e.g., a web address, a URL, a hyperlink, or another type of address or pointer). The present disclosure constructs an index or table of links from the set of webpages of interest. When a user provides a link for initiating a search, the present disclosure may identify which page it is and the entity or subject associated with that page. The present disclosure then performs a look-up in the table or index and returns all related pages, as suggested by FIG. 4C (the present disclosure may also (or instead) provide the user with an aggregated set of information including all related pages). The present disclosure may identify images relating to the link and determine the entity or subject associated with the images. The present disclosure then performs a look-up in the table or index and returns all related pages, as suggested by FIG. 4C.

### Scenario 2: Search for a Non-Specific Entity

Example use case: here, a user is looking at a piece of content (such as a news report) and would like to find other, related news items in order to learn more about the situation or event. Instead of generating keywords from the content of the page to use as a basis for searches performed by a search engine (such as Google® or Bing®), the user can instead use an embodiment of the present disclosure to “search by link” and more easily (and completely) obtain highly related (and presumably relevant) information from other webpages.

Information about a non-specific entity may be presented on different pages (e.g., different articles covering an issue, as expressed from different perspectives). In this example, the sources present related information, but would not be classified as a single entity, as the perspective of the articles could be different (and different facts or statistics may be presented).

When a user issues a link search request, the service may identify text, images, and/or metadata associated with the link received from the user. The service may then use the text, images, and/or metadata to search for pages relating to the images. The service may extract/construct a “topic vector” for each page (and/or perform a search based on each page to find an existing topic vector for the page). In this embodiment, a “topic vector” representation of each page may be based on word frequency, image content, metadata, or uniqueness on the page. This enables the present disclosure to build a higher-dimension space containing vectors representing the pages. Given the multi-dimensional topic vector, the present disclosure can compute a measure of the similarity or difference between the topic vector for one page and the topic vectors for other pages. The different dimensions may be weighted differently when evaluating the measure. Note that the relationships may be difficult to discover by a human viewer. In some cases, different machine learning methods could be used to train the models used to compute the measure. For example, product features can be labeled manually by a human for training purposes and applied to a neural network. The result of a trained neural network could then be used to compute the measure later.

This measure or metric may be expressed as a “distance” between the page's topic vector and the topic vector(s) of one or more other pages. Typically, this distance metric is then compared or evaluated by applying a suitable decision/thresholding process, and thereby sufficiently relevant or “related” pages may be identified. Note that further processing may also be applied to a set of such metrics in order to compare them or determine a suitable thresholding value for identifying the most useful or relevant pages. As compared with existing keyword query-based searches, the link-based search allows a user to perform a search using a vector that contains significantly more (and more accurate) information based on the full content of the page, including images and/or metadata associated with the page. In some embodiments, algorithms other than topic vector may be implemented, and the algorithms may include inverted index, document-term matrix, page rank, etc. In some embodiments, a computing device may generate a query based on the topic vector of the link or the document used for searches, and apply the query to a search engine provided by a third party (e.g., GOOGLE® OR BING®) to obtain a search result.

In addition, the present disclosure can analyze the behavior of the user, such as actions indicating a selection of certain content, activation of a link, time (hover) spent on the page, move over time, etc. and provide feedback to a ranking algorithm to provide better results for the “related” pages in future cases. And, based on user feedback, it may be possible to optimize the preferred distance between an input link and pages considered to be related in order to decide which pages (or which content) to present to the user (as suggested by FIG. 4D). For example, as described with reference to Scenario 2, a user can click on the link result returned to the user with a preview of the webpage. The system can know the pages that the user clicked on and how much time he/she spent on each page. Based on this information, the system may infer which page a user liked most according to the webpage searched. The system can use this as a new dimension to training a more user-specific model to compute distance. As an example, some users may prefer similar content or may like to search for complimentary content. This information can be used to improve the results returned to users when they search by the link. This is possible because of the rich information returned by the webpage when searching using a link and associated images (instead of a query, which is based on a limited set of words or keywords).

### C. Conclusion

It will be apparent to those having skill in the art that changes may be made to the details of the above-described embodiments without departing from the underlying principles of the present disclosure. In some cases, well-known structures and functions have not been shown or described in detail to avoid unnecessarily obscuring the description of aspects of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Where the context permits, singular or plural terms may also include the plural or singular term, respectively. For example, throughout this disclosure, the singular terms “a,” “an,” and “the” include plural referents unless the context clearly indicates otherwise. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, a step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.”

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing numerical values used in the specification and claims, are to be understood as being modified in all instances by the term “about.” Accordingly, unless indicated to the contrary, the numerical parameters set forth in the specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10 (e.g., any and all subranges having a minimum value of equal to or greater than 1 and a maximum value of equal to or less than 10, such as 5.5 to 10).

The disclosure set forth above is not to be interpreted as reflecting an intention that any claim or example requires more features than those expressly recited in that claim or example. Rather, as the preceding examples and the following claims reflect, inventive aspects lie in a combination of fewer than all features of any single foregoing disclosed embodiment. Thus, the preceding examples and the following claims are hereby expressly incorporated into the Detailed Description, with each claim standing on its own as a separate embodiment. This disclosure includes all permutations of the independent claims with their dependent claims.

What is claimed is:

1. A method comprising:
receiving, from a computing device and by one or more processors of a server, a request comprising a link directed to source content;
determining, by the one or more processors, that a database associated with the server does not comprise the link, the database storing information of a plurality of entities that each correspond to one or more links; and
in response to determining that the database associated with the server does not comprise the link:
analyzing, by the one or more processors, the source content to identify one or more images associated with the link,
initiating, by the one or more processors, an image search based at least in part on the one or more images,
receiving, by the one or more processors, one or more related images corresponding to the image search,
determining, by the one or more processors, one or more related links associated with the one or more related images, the one or more related links directed to one or more related source contents,
analyzing, by the one or more processors, the one or more related source contents to identify one or more parameters relating to at least a portion of the source content, and
providing, by the one or more processors, a search result to the computing device, the search result comprising the one or more parameters.

2. The method of claim 1 wherein:
the computing device is a first computing device, the link is a first link, the request is a first request, and the source content is first source content; and
the method further comprises—
receiving, from a second computing device and by the one or more processors, a second request comprising a second link directed to second source content,
determining, by the one or more processors, that the database associated with the server comprises the second link, and
in response to determining that the database associated with the server comprises the second link:
identifying, by the one or more processors, an entity corresponding to the second link;
generating, by the one or more processors, an initial search result comprising information relating to the entity; and
providing, by the one or more processors, the initial search result to the second computing device.

3. The method of claim 2, further comprising:
supplementing the initial search result by—
analyzing, by the one or more processors, the second source content to identify one or more images associated with the second link;
performing, by the one or more processors, a second image search based on the one or more images associated with the second link;
receiving, by the one or more processors, one or more second related images corresponding to the second image search;
determining, by the one or more processors, one or more second related links associated with the one or more second related images corresponding to the second image search, the one or more second related links directed to one or more second related source contents;
analyzing, by the one or more processors, the one or more second related source contents to identify one or more second parameters relating to at least the portion of the second source content; and
generating, by the one or more processors, a supplemental search result by supplementing the initial search result with the one or more second parameters; and
providing, by the one or more processors, the supplemental search result to the second computing device.

4. The method of claim 3 wherein:
the method further comprises determining that the initial search result does not comprise sufficient information; and
generating the supplemental search result in response to determining that the initial search result does not comprise sufficient information.

5. The method of claim 1, further comprising determining, by the one or more processors, the one or more related links based at least in part on metadata associated with the one or more related images.

6. A method comprising:
receiving, from a computing device and by one or more processors of a server, a request comprising a link directed to source content;
determining, by the one or more processors, that a database associated with the server comprises the link, and
in response to determining that the database associated with the server comprises the link:
identifying, by the one or more processors, an entity corresponding to the link,
generating, by the one or more processors, an initial search result comprising information relating to the entity, and
providing, by the one or more processors, the initial search result to the computing device.

7. The method of claim 6, further comprising:
supplementing the initial search result by—
analyzing, by the one or more processors, the source content to identify one or more images associated with the link;
performing, by the one or more processors, an image search based on the one or more images associated with the link;
receiving, by the one or more processors, one or more related images corresponding to the image search;
determining, by the one or more processors, one or more related links associated with the one or more related images corresponding to the image search, the one or more related links directed to one or more related source contents;
analyzing, by the one or more processors, the one or more related source contents to identify one or more parameters relating to at least a portion of the source content; and
generating, by the one or more processors, a supplemental search result by supplementing the initial search result with the one or more parameters; and
providing, by the one or more processors, the supplemental search result to the computing device.

8. The method of claim 7 wherein:
the method further comprises determining that the initial search result does not comprise sufficient information; and
generating the supplemental search result in response to determining that the initial search result does not comprise sufficient information.

9. The method of claim 7, further comprising determining, by the one or more processors, the one or more related links based at least in part on metadata associated with the one or more related images.

10. A system comprising:
one or more processors; and
memory configured to maintain instructions executable by the one or more processors, the instructions, when executed by the one or more processors, causing the system to perform operations comprising:
receiving, from a computing device, a request comprising a link directed to source content,
determining that a database does not comprise the link, the database storing information of a plurality of entities that each correspond to one or more links, and
in response to determining that the database does not comprise the link:
analyzing the source content to determine one or more images associated with the link;
initiating, based at least in part on the one or more images, a search for one or more related images;
receiving the one or more related images identified based on the search;
determining one or more related links associated with the one or more related images, the one or more related links directed to one or more related source contents;
analyzing the one or more related source contents to identify one or more parameters relating to at least a portion of the source content; and
providing a search result to the computing device, the search result comprising the one or more parameters.

11. The system of claim 10 wherein the instructions further cause the one or more processors to:
the computing device is a first computing device, the link is a first link, the request is a first request, and the source content is first source content; and
wherein the instructions further cause the one or more processors to—
receiving, from a second computing device and by the one or more processors, a second request comprising a second link directed to second source content,
determining, by the one or more processors, that the database comprises the second link, and
in response to determining that the database comprises the second link—
identifying an entity corresponding to the second link;
generating an initial search result comprising information relating to the entity; and
providing the initial search result to the second computing device.

12. The system of claim 11 wherein the instructions further cause the one or more processors to:
supplement the initial search result, wherein, to supplement the initial search result, the instructions further cause the one or more processors to—
analyzing the second source content to identify one or more images associated with the second link;
performing a second image search based on the one or more images associated with the second link;
receiving one or more second related images corresponding to the second image search;
determining one or more second related links associated with the one or more second related images corresponding to the second image search, the one or more second related links directed to one or more second related source contents;
analyzing the one or more second related source contents to identify one or more second parameters relating to at least the portion of the second source content; and
generating a supplemental search result by supplementing the initial search result with the one or more second parameters; and
provide the supplemental search result to the second computing device.

13. The system of claim 12 wherein the instructions further cause the one or more processors to:
determining that the initial search result does not comprise sufficient information,
wherein the instructions further cause the one or more processors to supplement the initial search result in response to determining that the initial search result does not comprise sufficient information.

14. The system of claim 10 wherein the instructions further cause the one or more processors to determine the one or more related links based at least in part on metadata associated with the one or more related images.
